(19) United States
(12) Patent Application Publication
(10) Pub. No.: US 2019/0136624 A1
(43) Pub. Date: May 9, 2019

(54) MECHANICAL STRUCTURE

(71) Applicant: WAN YU CHEN, NEW TAIPEI CITY (TW)

(72) Inventor: WAN YU CHEN, NEW TAIPEI CITY (TW)

(21) Appl. No.: 16/183,041

(22) Filed: Nov. 7, 2018

(30) Foreign Application Priority Data
Nov. 7, 2017 (CN) 201721472774.X
Dec. 11, 2017 (CN) 201721720518.8
Apr. 25, 2018 (CN) 201820602486.X

(51) Int. Cl. E06C 7/50; F16B 7/04

(52) U.S. Cl. CPC E06C 7/50; E06C 1/39; F16B 7/044

(57) ABSTRACT

The present disclosure provides a mechanical structure, including a first link having a first end and a second end, a second link having a first end and a second end, an operative portion, wherein the operative portion comprises a first portion and a second portion unparalleled to the first portion, a connection member connecting the first end of the first link, the first end of the second link, and the first portion of the operative portion, a first protrusion on the second portion of the operative portion, a second protrusion on the second portion of the operative portion, wherein the first link is in contact with the first protrusion and the second link is in contact with the second protrusion when a first angle is between the first link and the second link.

### CROSS REFERENCE TO RELATED APPLICATION

This application claims the benefit of Chinese application CN201721472774.X, filed Nov. 7, 2017, Chinese application CN201721720518.8, filed Dec. 11, 2017, and Chinese application CN201820602486.X, filed Apr. 25, 2018. The disclosure of these applications is hereby incorporated by reference in their entirety.

### BACKGROUND

When a user has intention to reach an elevated position, a mechanical structure, such as a supporter, a ladder, or the like, may provide an elevated standpoint and bear the weight of the user on such standpoint. In order to improve the durability and reliability of a mechanical structure and further ameliorate safety and/or efficiency of using a mechanical structure as an elevated standpoint, an improved mechanical structure is entailed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a perspective view showing a mechanical structure in a first state, in accordance with some embodiments of the present disclosure.

FIG. 2 is a side view showing a mechanical structure in a second state, in accordance with some embodiments of the present disclosure

FIG. 2A is an enlarged schematic view showing a side view of a top portion of a mechanical structure, in accordance with some embodiments of the present disclosure.

FIG. 3 is a perspective view showing a connector in a first state, in accordance with some embodiments of the present disclosure.

FIG. 3A is an enlarged schematic view showing a front view of a connector in a first state, in accordance with some embodiments of the present disclosure.

FIG. 4 is a perspective view showing a connector in a second state, in accordance with some embodiments of the present disclosure.

FIG. 4A is an enlarged schematic view showing a front view of a connector in a second state, in accordance with some embodiments of the present disclosure.

FIG. 5 is an exploded view of a connector, in accordance with some embodiments of the present disclosure.

FIG. 6 is a perspective view showing a first link, in accordance with some embodiments of the present disclosure.

FIG. 6A is a top view showing a first link, in accordance with some embodiments of the present disclosure.

FIG. 7 is a perspective view showing a second link, in accordance with some embodiments of the present disclosure.

FIG. 8 is a perspective view showing a connector in a first state, in accordance with some embodiments of the present disclosure.

FIG. 9 is an exploded view of a connector, in accordance with some embodiments of the present disclosure.

FIG. 10A is a cross sectional view of a control portion, an operative portion, and a positioning member in a first state, in accordance with some embodiments of the present disclosure.

FIG. 10B is a cross sectional view of a control portion, an operative portion, and a positioning member in a second state, in accordance with some embodiments of the present disclosure.

FIG. 10C is an enlarged schematic view showing a front view of a connector in a first state, in accordance with some embodiments of the present disclosure.

FIG. 10D is an enlarged schematic view showing a front view of a connector in a second state, in accordance with some embodiments of the present disclosure.

FIG. 11A is a perspective view showing an operative portion, in accordance with some embodiments of the present disclosure.

FIG. 11B is a cross sectional view showing an operative portion, in accordance with some embodiments of the present disclosure.

FIG. 11C is a bottom view showing an operative portion, in accordance with some embodiments of the present disclosure.

FIG. 12 is a perspective view showing a connector in a first state, in accordance with some embodiments of the present disclosure.

FIG. 13 is an exploded view of a connector, in accordance with some embodiments of the present disclosure.

FIG. 14A is a cross sectional view of a control portion, an operative portion, and a positioning member in a first state, in accordance with some embodiments of the present disclosure.

FIG. 14B is a cross sectional view of a control portion, an operative portion, and a positioning member in a second state, in accordance with some embodiments of the present disclosure.

FIG. 14C is an enlarged schematic view showing a front view of a connector in a first state, in accordance with some embodiments of the present disclosure.

FIG. 14D is an enlarged schematic view showing a front view of a connector in a second state, in accordance with some embodiments of the present disclosure.

FIG. 15A is a perspective view showing an operative portion, in accordance with some embodiments of the present disclosure.

FIG. 15B is a cross sectional view showing an operative portion, in accordance with some embodiments of the present disclosure.

FIG. 15C is a bottom view showing an operative portion, in accordance with some embodiments of the present disclosure.

FIG. 16 is a perspective view showing a shaft base, in accordance with some embodiments of the present disclosure.

FIG. 17 is a perspective view showing a positioning member, in accordance with some embodiments of the present disclosure.

FIG. 18A is a perspective view showing a mechanical structure in a first state, in accordance with some embodiments of the present disclosure.

FIG. 18B is a perspective view showing a mechanical structure in a first state, in accordance with some embodiments of the present disclosure.

FIG. 19 is a perspective view showing a mechanical structure in a first state, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the terms “substantially,” “approximately,” or “about” generally means within a value or range which can be contemplated by people having ordinary skill in the art. Alternatively, the terms “substantially,” “approximately,” or “about” means within an acceptable standard error of the mean when considered by one of ordinary skill in the art. People having ordinary skill in the art can understand that the acceptable standard error may vary according to different technologies. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the terms “substantially,” “approximately,” or “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

Conventionally, a user may be entailed to stow or extend a mechanical structure by directly contacting a link of the connector. However, a link of the connector is often damaged, stained, or having sharp edges, which may induce safety risk or health problems. A user may also be nipped by the connector or the mechanical structure due to lack of protection, thus the user may be exposed to the risk of injury. In addition, a mechanical structure without a proper limitation with regard to rotation may cause over-rotation, which may induce collision by the ends thereof, thereby reliability and durability of the mechanical structure is deteriorated.

In order to solve the aforementioned issues, an improvement on a mechanical structure is admirably entailed.

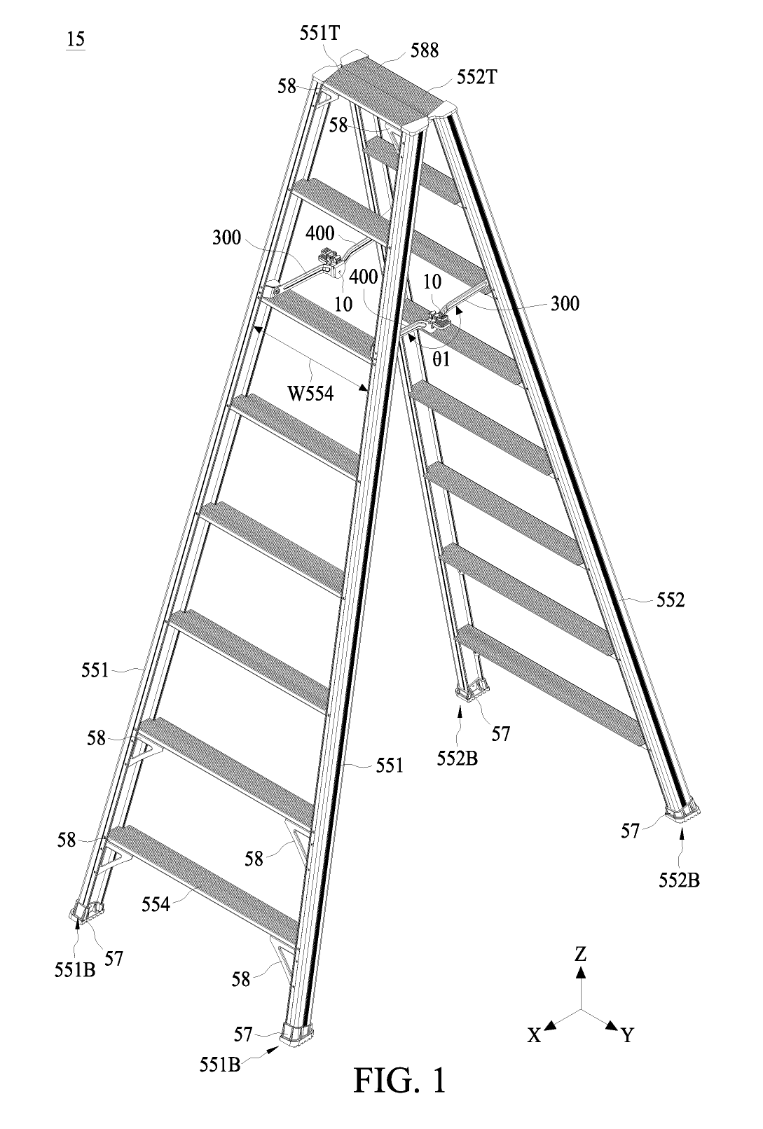

Referring to FIG. 1, FIG. 1 is a perspective view showing a mechanical structure in a first state, in accordance with some embodiments of the present disclosure. A mechanical structure 15 may include a first part 551, a second part 552, and a connector 10. The first part 551 and the second part 552 may be made by a material having an adequate mechanical strength to bear a weight of human, wherein the material may include metal, steel, stainless steel, aluminum, metal alloy, or other suitable materials. The first part 551 has a connecting board 554, wherein a width W554 of the connecting board 554 may be at least greater than a width of a human foot, e.g. 3 cm, so that the connecting board 554 can serve as a standpoint for a user and thereby support the user. The second part 552 may, or may not have a connecting board. In some embodiments, the second part 552 may include a supporting structure for ameliorating mechanical strength and/or stability, which may, or may not allow a user to step onto. In some embodiments, a strengthening structure 58 for improving the strength of the connecting board 554 is connected between the connecting board 554 and the first part 551, and/or connected between the connecting board 554 and the second part 552. The strengthening structure 58 may be a structure similar to triangle shape, a hollowed triangle shape, polygon shape, or the like.

The first part 551 has a top surface 551T and the second part 552 has a top surface 552T. In some embodiments, the top surface 551T and the top surface 552T may be coplanar, which constitutes a platform 558. In some other embodiments, the top surface 551T and the top surface 552T are not coplanar. In some embodiments, the first part 551 has a shape tapering toward the top surface 551T, and the second part 552 has a shape tapering toward the top surface 552T. In some embodiments, the first part 551 and/or the second part 552 may include hollowed chambers.

The connector 10 connected between the first part 551 and the second portion 552. The mechanical structure 15 may optionally include two or more connector 10 having an end connected to the first part 551, and another end connected to the second part 552. It is noteworthy that in some embodiments, two connectors are identical as two connectors 10 are disposed on the opposite sides of the mechanical structure 15 and facing in opposite direction, with one connector 10 may have the first link 300 being connected to the first part 551 and the second link 400 being connected to the second part 552, while another one connector 10 may have the first link 300 being connected to the second part 552 and the second link 400 being connected to the first part 551. In some other embodiments, two connectors 10 are disposed in substantially symmetrical or geometrically opposite fashion, wherein the first links 300 of both the connectors 10 are connected to the first part 551 and the second links 400 of both the connectors 10 are connected to the second part 552. Those skilled in the art should also realize that such symmetrically designed configurations do not depart from the spirit and scope of the present disclosure, as duplicated explanations are omitted hereinafter.

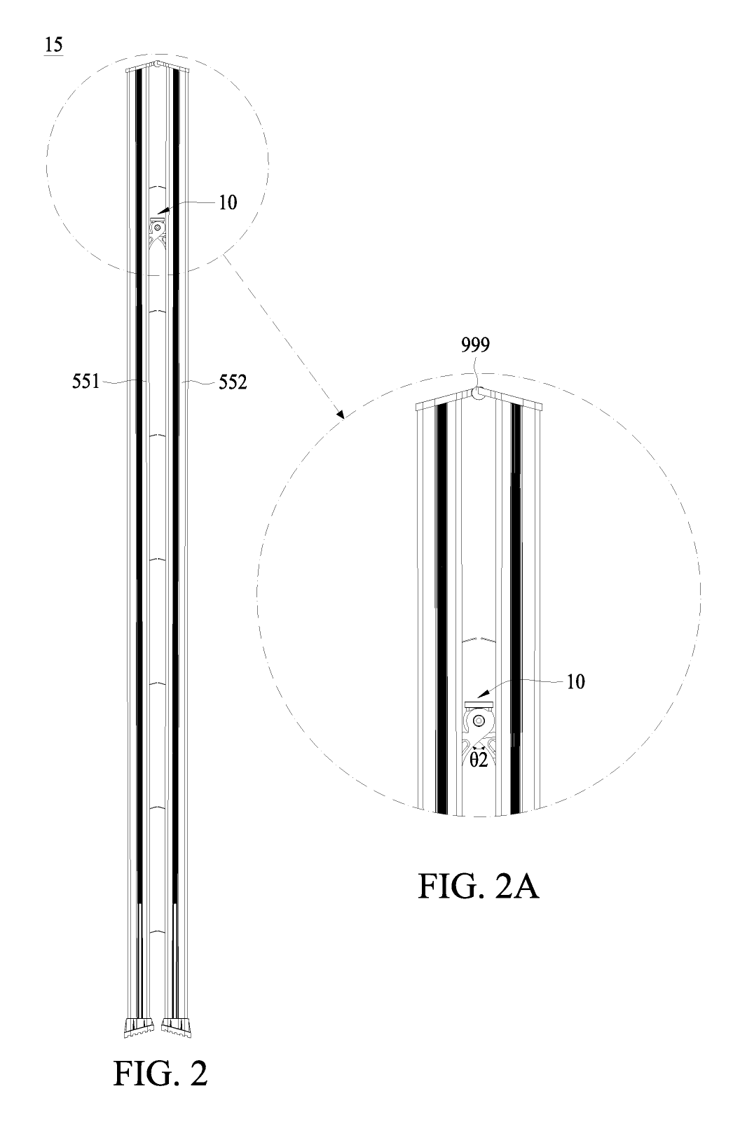

In some embodiments, the mechanical structure 15 optionally include a hinge 999 (shown in FIG. 2A) connected between the first part 551 and the second part 552, wherein the hinge 999 allows the first part 551 and the second portion 552 to relatively rotates around a given rotational axis, as an end 551B of the first part 551 distal to the top surface 551T can move toward or move away from an end 552B of the second part 552 distal to the top surface 552T. In some embodiments, the mechanical structure 15 may include two or more hinges 400, each on one side of the top portion of the mechanical structure 15, to facilitate the smoothness and the stability of the rotation thereof.

In some embodiments, the mechanical structure 15 further include a pad 57 covering a bottom surface of the first part 551 and/or a bottom surface of the second part 552. The pad 57 may be materials with higher friction coefficient, such as plastic, rubber, polymer, or other suitable compositions. The pad 57 prevents the mechanical structure 15 from easily flipping over or gliding, thus reduces the risk of inducing injuries.

Referring to FIG. 1, FIG. 2 and FIG. 2A, FIG. 2 is a side view showing a mechanical structure in a second state, FIG. 2A is an enlarged schematic view showing a side view of a top portion of a mechanical structure, in accordance with some embodiments of the present disclosure. FIG. 1 illustrates a position of the mechanical structure 15 standing on the end 551B and the end 552B, wherein a first angle θ₁ is between the first link 300 and the second link 400 of the connector 10, wherein such position is denoted as a first state hereinafter. In some embodiments, the first angle θ₁ is an obtuse angle. In some embodiments, the first angle θ₁ is about 180 degrees. FIG. 2 and FIG. 2A illustrates the position of the mechanical structure 15 being stowed (i.e. a distance between the end 551B and the end 552B are closer than FIG. 1 thereof), wherein a second angle θ₂ less than the first angle θ₁ is between the first link 300 and the second link 400 of the connector 10, as such position is denoted as a second state hereinafter. The mechanical structure 15 in the first state provides a stable structure and a standpoint for a user to reach an elevated position; while the mechanical structure 15 in the second state allows a user to transport the mechanical structure 15 easier and saves space with regard to storage.

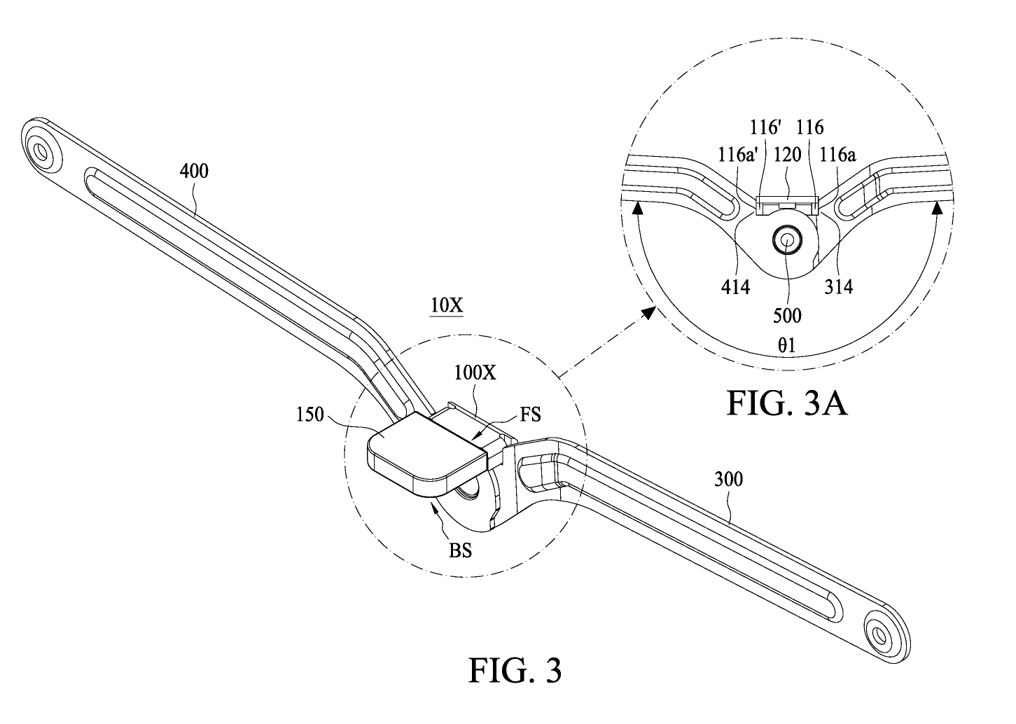

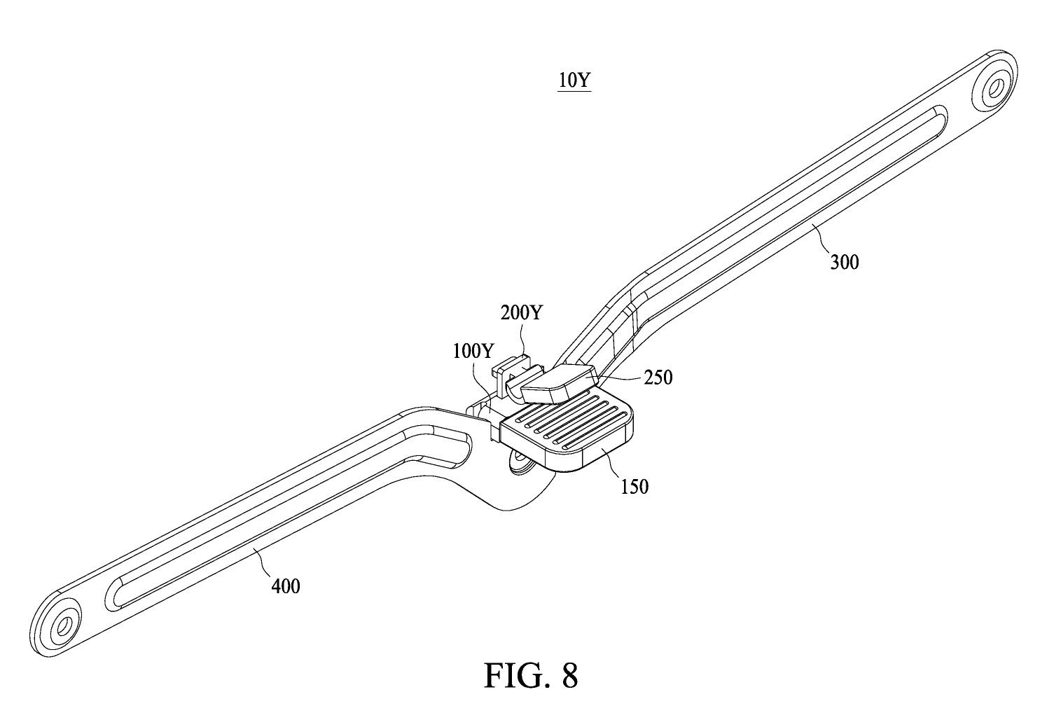

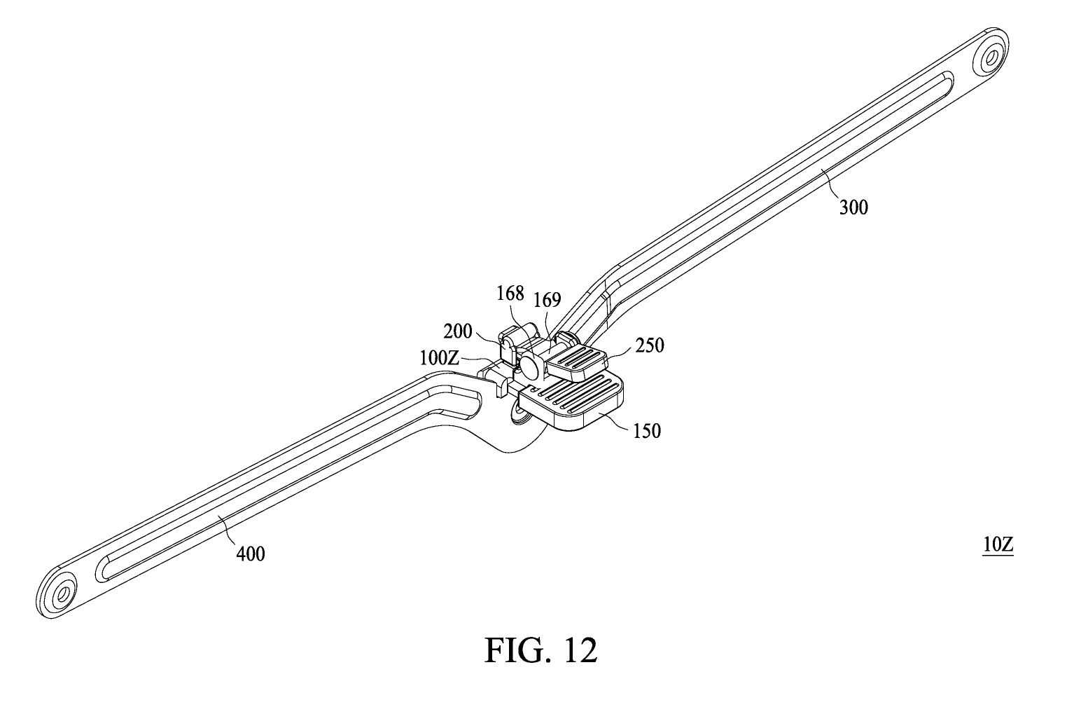

Hereinafter a connector 10X (illustrated in FIG. 3 to FIG. 7), a connector 10Y (illustrated in FIG. 8 to FIG. 11C), and a connector 10Z (illustrated in FIG. 12 to FIG. 17) are variations of the aforesaid connector 10, that is, any connector 10 provided in the present disclosure can be substituted by one or more of the a connector 10X, a connector 10Y, and a connector 10Z.

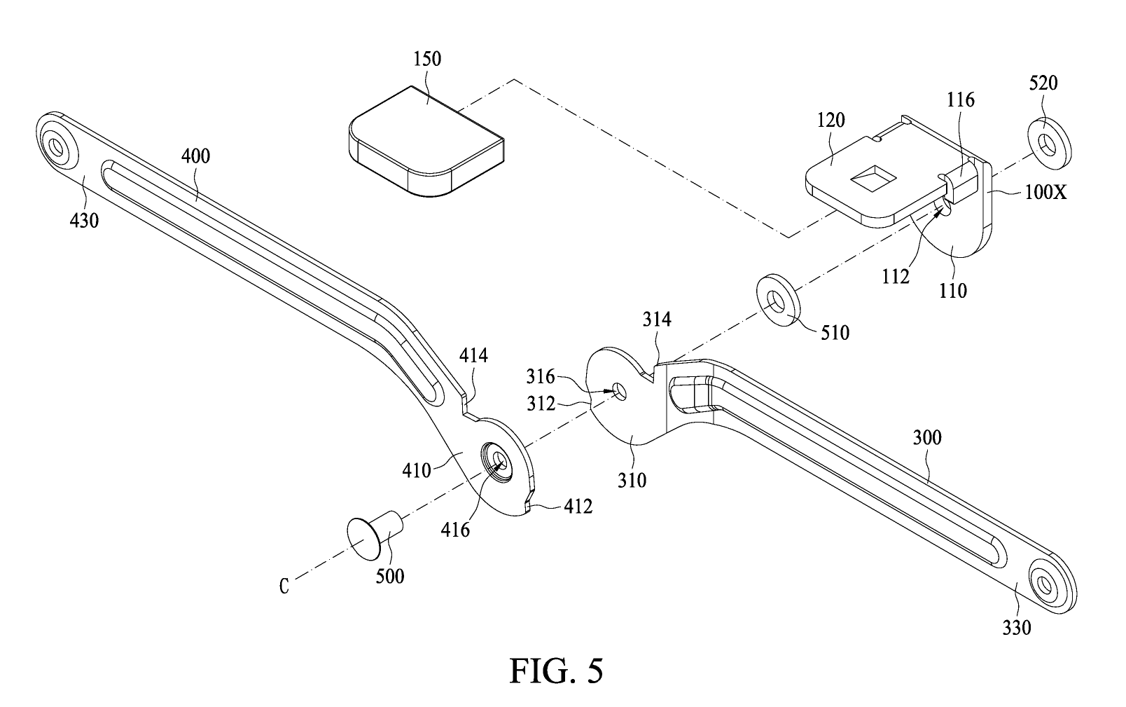

Referring to FIG. 3, FIG. 3A, and FIG. 5, FIG. 3 is a perspective view showing a connector 10X in a first state, FIG. 3A is an enlarged schematic view showing a front view of a connector 10X in a first state, FIG. 5 is an exploded view of a connector 10X, in accordance with some embodiments of the present disclosure. The connector 10X at least includes a first link 300, a second link 400, an operative portion 100X, and a connection member 500. The operative portion 100X includes a first portion 110 and a second portion 120, wherein the second portion 120 is unparalleled to the first portion 110. In some embodiments, an angle between the first portion 110 and the second portion 120 is about 90 degrees. The second portion 120 of the operative portion 100X has a first side FS proximal to the top surface 551T of the first part 551 (shown in FIG. 1) and a second side BS opposite to the first side FS. A hole 112 is configured on the first portion 110 of the operative portion 100X.

The first link 300 has a first end 310 and a second end 330 opposite to the first end 310; while the second link 400 has a first end 410 and a second end 430 opposite to the first end 410. The connection member 500 rotatably connects the first link 300 and the second 400 to the first portion 110 of the operative portion 100X. The connection member 500 allows the first link 300 and the second link 400 to rotate around an axis C. In some embodiments, the connection member 500 penetrates a first aperture 316 configured on the first end 310 of the first link 300, a first aperture 416 configured on the first end 410 of the second link 400, and the hole 112 configured on the first portion 110 of the operative portion 100X. In some embodiments, the connector 10X may further include a washer 510 to ameliorate the smoothness of rotation. In some embodiments, the connection member 500 is a rivet or a screw set, as a ring 520 or a nut is optionally included in the connector 10X to engage with the connection member 500 or to ameliorate the smoothness of rotation.

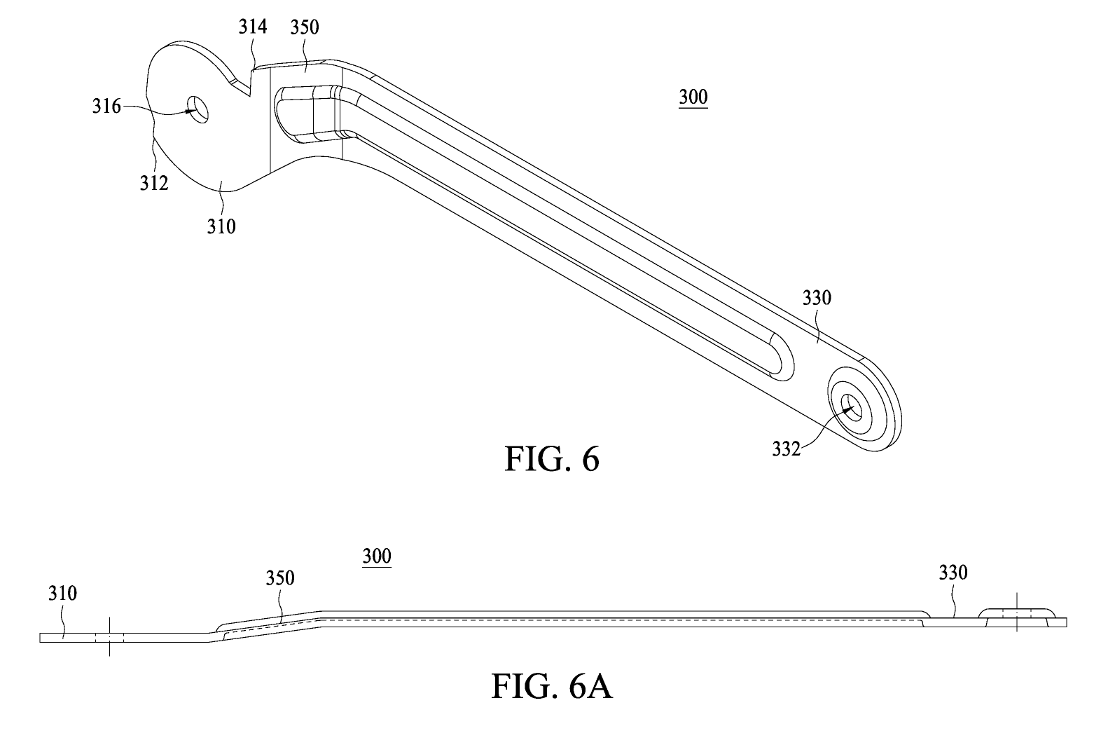

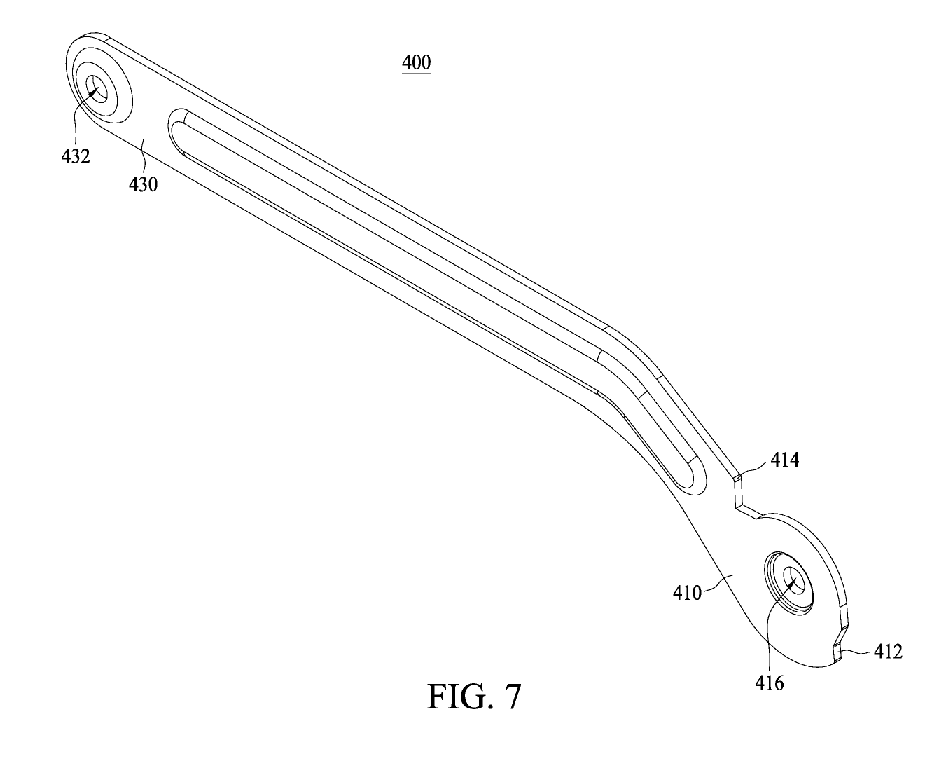

Referring to FIG. 5, FIG. 6, FIG. 6A and FIG. 7, FIG. 6 is a perspective view showing a first link, FIG. 6A is a top view showing a first link, and FIG. 7 is a perspective view showing a second link, in accordance with some embodiments of the present disclosure. The second end 330 of the first link 300 is connected to one of the first part 551 or the second part 552, as the second end 430 of the second link 400 is connected to the other one of the first part 551 or the second part 552. In some embodiments, a second aperture 332 is configured on the second end 330 of the first link 300 and a second aperture 432 is configured on the second end 430 of the second link 400, thereby the connector 10X can be fixated to the mechanical structure 15 with fixtures or other suitable fixing structures with simplified fabrication process. In some embodiments, a slant portion 350 may be optionally included with regard to ensure the balance of the connector 10X, that is, the second aperture 332 of the first link 300 and the second aperture 432 of the second link 400 is on a same plane parallel to X-Z plane (shown in FIG. 1), wherein +Z is the height direction of the mechanical structure 15.

Referring back to FIG. 3, FIG. 3A, FIG. 5, FIG. 6, and FIG. 6A, when the mechanical structure 15 is in the first state, the second portion 120 of the operative portion 100X engages with the first link 300 and the second link 400, as the first angle θ₁ is between the first link 300 and the second link 400 of the connector 10. A first protrusion 116 and a second protrusion 116′ are disposed on the second side BS of the operative portion 100X. A first extension limiting portion 314 and a second extension limiting portion 414 are configured on the first end 310 of the first link 300 and the first end 410 of the second link 400 respectively in order to contact with the first protrusion 116 and the second protrusion 116′ when the mechanical structure 15 (shown in FIG. 1) is in the first state, thus preventing over-rotation between the first link 300 and the second link 400, or avoiding over-extension of the connector 100X, further improve the durability of the mechanical structure 15. In some embodiments, the first extension limiting portion 314 engages with a bottom surface 116b and/or a sidewall 116a of the first protrusion 116; while the second extension limiting portion 414 engages with a bottom surface 116b′ and/or a sidewall 116a′ of the second protrusion 116′. It should be noted that the first protrusion 116 and the second protrusion 116′ can be a connected structure or separated structure.

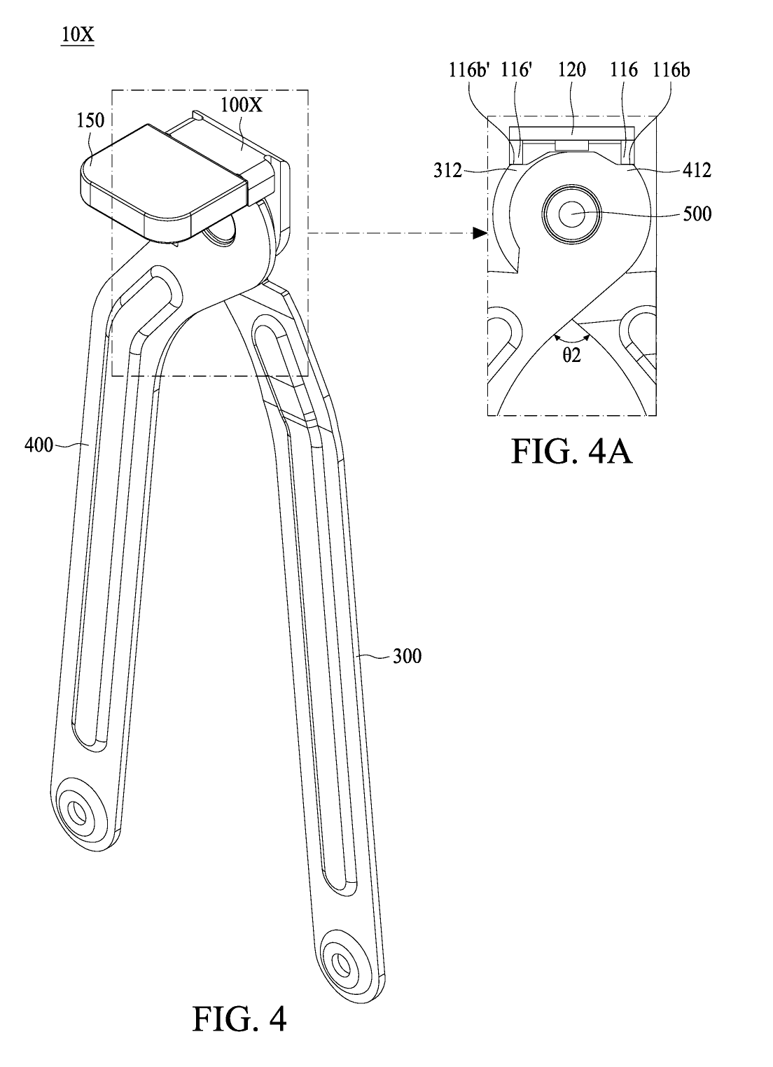

Referring to FIG. 1, FIG. 3, FIG. 3A, FIG. 4, FIG. 4A and FIG. 5, FIG. 4 is a perspective view showing a connector 10X in a second state, and FIG. 4A is an enlarged schematic view showing a front view of a connector 10X in a second state, in accordance with some embodiments of the present disclosure. When the mechanical structure 15 is in the first state, a force along +Z direction (i.e. height direction) can be applied on the second side BS of the second portion 120 of the operative portion 100X, thus the second portion 120 of the operative portion 100X may be moved away from the connection member 500 and allow the first protrusion 116 and the second protrusion 116′ to respectively disengage with the first extension limiting portion 314 of the first link 300 and the second extension limiting portion 414 of the second link 400. Thereby the first link 300 and the second link 400 is allowed to be rotated around the axis C while the second end 330 of the first link 300 and the second end 430 of the second link 400 can move toward each other. As a result, the mechanical structure 15 can be stowed to the second state, wherein the second angle θ₂ less than the first angle θ₁ is between the first link 300 and the second link 400. In some embodiments, in order to avoid impingement (e.g. accidental collision or clamping a user's finger) between the first part 551 and the second part 552, the rotation of the first link 300 and the second link 400 is limited by the configuration of the first protrusion 116 and the second protrusion 116′. Alternatively stated, an angle between the first link 300 and the second link 400 is in a range from the first angle θ₁ to the second angle θ₂. A first stowing limiting portion 312 of the first link 300 at least contacts with the bottom surface 116b′ of the second protrusion 116′; while a second stowing limiting portion 412 of the second link 400 engages with a bottom surface 116b of the first protrusion 116 when the mechanical structure 15 is in the second state. By virtue of the configuration of having a first protrusion 116 and the second protrusion 116′ to contact with the first link 300 and the second link 400 in the first state or in the second state, the stability and the safety of the mechanical structure 15 can be improved. In addition, the contact surfaces between the first link 300, the second link 400, the first protrusion 116 and the second protrusion 116′ may be different between the first state and the second state, thus the durability of the connector 10X can be improved.

When an angle between the first link 300 and the second link 400 is less than the first angle θ₁, by increasing the angle between the first link 300 and the second link 400 from an angle less than the first angle θ₁ (e.g. the second angle θ₂) to the first angle θ₁, as well as an angle between the first part 551 and the second part 552, the second portion 120 of the operative portion 100X moves toward the connection member 500 and thus engages with the first extension limiting portion 314 and the second extension limiting portion 414, wherein the mechanical structure 15 is thereby transferred to the first state as the first link 300 and the second link 400 are locked.

In some embodiments, a sleeve 150 may at least cover a portion of the second portion 120 of the operative portion 100X so that a user can apply force on a mild surface, wherein a sharp edge, burr, metal edge, or rough surface can be covered by the sleeve 150, thus incise injury can be avoided. The sleeve 150 may include plastic, polymer, rubber, organic substances, or the like. In some embodiments, the second portion 120 of the operative portion 100X may include a mating engagement structure, such as protrusions and recesses, to ameliorate adhesion with the sleeve 150.

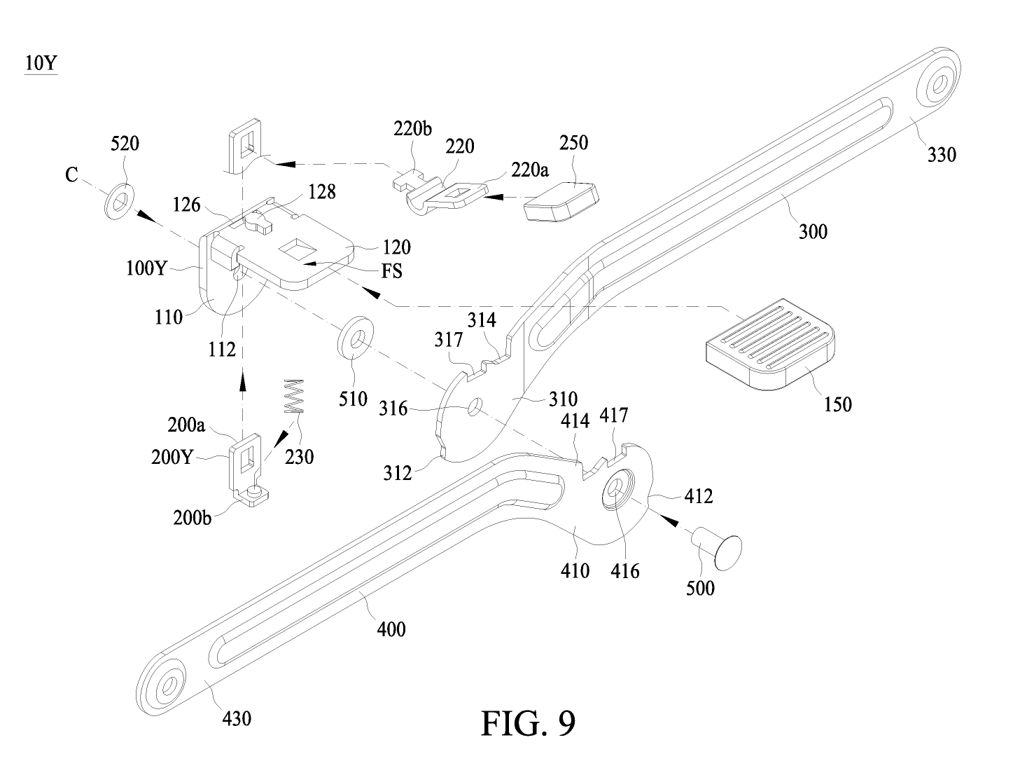

Referring to FIG. 8 and FIG. 9, FIG. 8 is a perspective view showing a connector 10Y in a first state, and FIG. 9 is an exploded view of a connector 10Y, in accordance with some embodiments of the present disclosure. Note that hereinafter elements in FIG. 8 to FIG. 11C being the same as or similar to aforesaid counterparts within FIG. 3 to FIG. 7 are denoted by the same reference numerals, as duplicated explanations are omitted. The connector 10Y at least includes a first link 300, a second link 400, an operative portion 100Y, a positioning member 200Y, a control portion 220, and a connection member 500. The operative portion 100Y includes a first portion 110 and a second portion 120, wherein the second portion 120 is unparalleled to the first portion 110. In some embodiments, an angle between the first portion 110 and the second portion 120 is about 90 degrees. In some embodiments, no relative motion occurs between the first portion 110 and the second portion 120 herein. The second portion 120 of the operative portion 100Y has a first side FS proximal to the top surface 551T of the first part 551 (shown in FIG. 1) and a second side BS opposite to the first side FS. A hole 112 is configured on the first portion 110 of the operative portion 100Y.

The connection member 500 rotatably connects the first link 300 and the second 400 to the first portion 110 of the operative portion 100Y. The connection member 500 allows the first link 300 and the second link 400 to rotate around an axis C. In some embodiments, the connection member 500 penetrates a first aperture 316 configured on the first end 310 of the first link 300, a first aperture 416 configured on the first end 410 of the second link 400, and the hole 112 configured on the first portion 110 of the operative portion 100Y.

The control portion 220 is disposed on the first side FS of the operative portion 100Y, wherein the control portion has a first end 220a and a second end 220b proximal to the first portion 110 of the operative portion 100Y. The positioning member 200Y is configured to penetrate an opening 126 configured on the second portion 120 of the operative portion 100Y, wherein the positioning member 200Y has a first end 200a and a second end 200b opposite to the first end 200a, wherein the first end 200a is connected to the second end 220b of the control portion 220. In some embodiments, an elastic member 230 is disposed between second end 200b of the positioning member 200Y and the second side BS of the operative portion 100Y. The elastic member 230 may be a spring, a coil, or the like. Since the elastic member 230 may be compressed (i.e. shorter than a natural length thereof), the elastic member 230 may be configured to constantly apply a force on the positioning member 200Y to press against the first link 300 and/or the second link 400 along a direction toward the connection member 500 (and away from the operative portion 100Y).

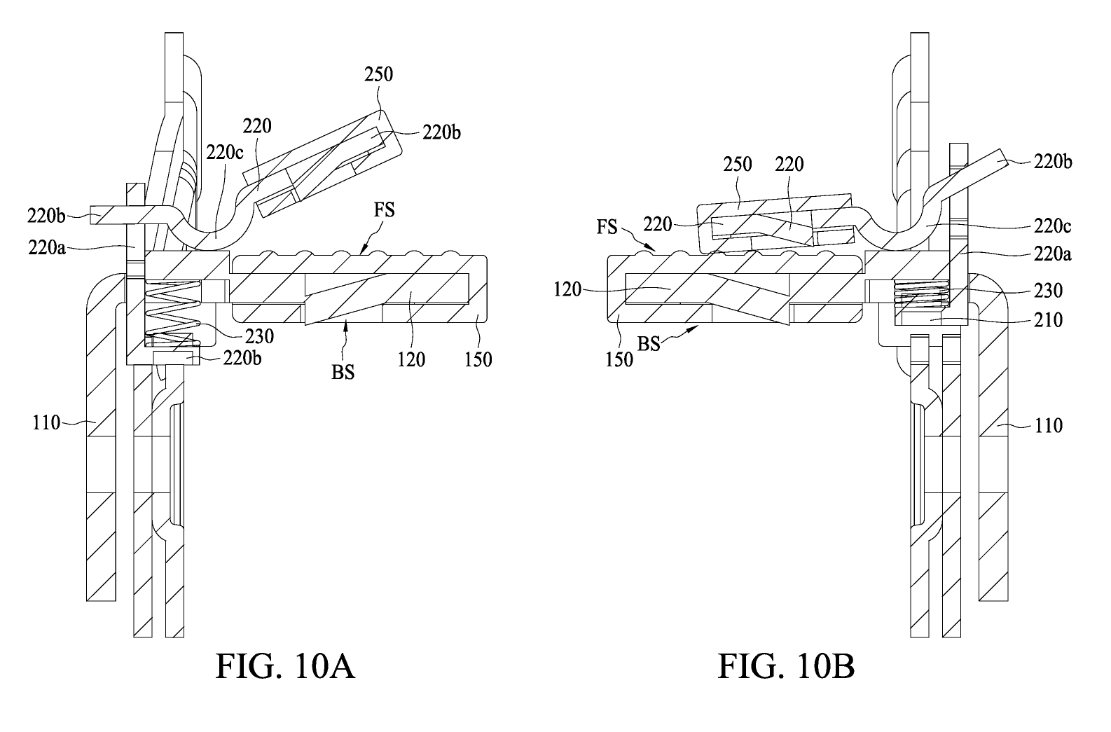

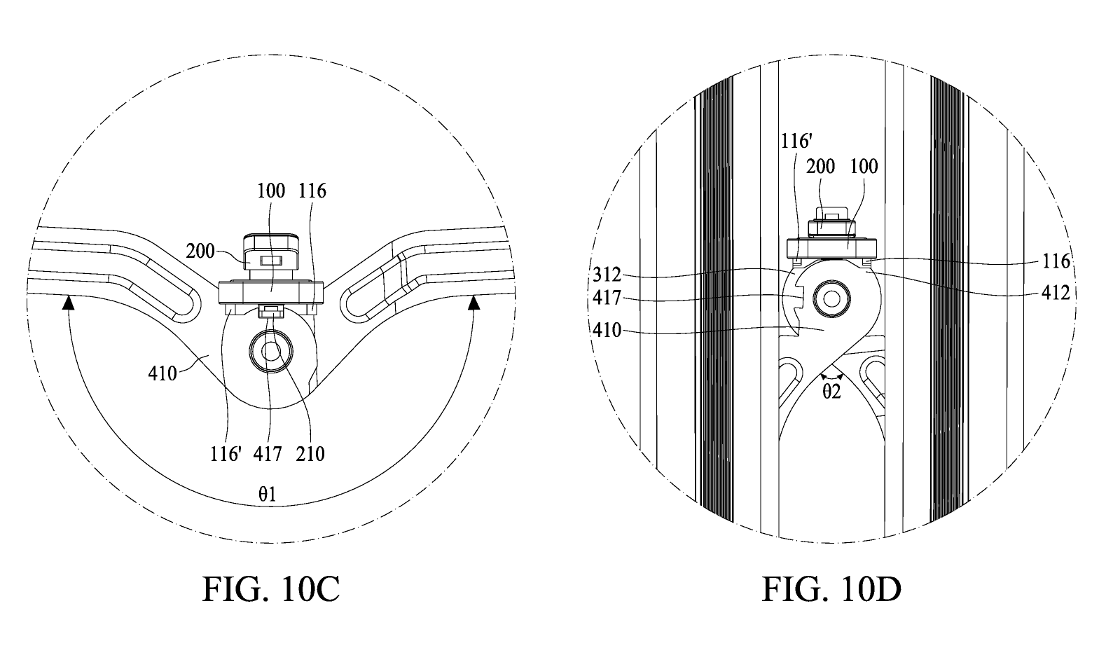

Referring to FIG. 8, FIG. 9, FIG. 10A, and FIG. 10C, FIG. 10A is a cross sectional view of a control portion, an operative portion, and a positioning member in a first state, and FIG. 10C is an enlarged schematic view showing a front view of a connector in a first state, in accordance with some embodiments of the present disclosure. When the mechanical structure 15 is in the first state, a first angle θ₁ is between the first link 300 and the second link 400 of the connector 10Y. In some embodiments, the first angle θ₁ is an obtuse angle. In some embodiments, the first angle θ₁ is 180 degrees. A first extension limiting portion 314 and a second extension limiting portion 414 are configured on the first end 310 of the first link 300 and the first end 410 of the second link 400 respectively in order to contact with the first protrusion 116 and the second protrusion 116′ when the mechanical structure 15 is in the first state, thus preventing over-rotation between the first link 300 and the second link 400, or avoiding over-extension of the connector 100Y, further improve the durability of the mechanical structure 15, similar to the counterpart previously discussed in FIG. 3 and FIG. 3A.

In addition, the first link 300 includes a first positioning portion 317 recessed toward the connection member 500, and the second link 400 includes a second positioning portion 417 recessed toward the connection member 500. In the first state, the first positioning portion 317 and the second positioning portion 417 are aligned, wherein the second end 200b of the positioning member 200Y engages with the first positioning portion 317 and the second positioning portion 417 and thus fixates the first link 300 and the second link 400. Alternatively stated, second end 200b of the positioning member 200Y is configured to apply a force against the first positioning portion 317 and the second positioning portion 417 so that the first link 300 and the second link 400 is locked and may not be accidently rotated in an unpremeditated fashion.

The control portion 220 directly contacts with the second portion 120 of the operative portion 100Y. In some embodiments, the control portion 220 may include a curved portion 220c concaved toward the second portion 120 of the operative portion 100Y, so that a contacted area/line/point between the control portion 220 and the second portion 120 of the operative portion 100Y can serve as a rotation pivot.

Referring to FIG. 8, FIG. 9, FIG. 10A, FIG. 10B, and FIG. 10D, FIG. 10B is a cross sectional view of a control portion, an operative portion, and a positioning member in a second state, and FIG. 10D is an enlarged schematic view showing a front view of a connector in a second state, in accordance with some embodiments of the present disclosure. When the mechanical structure 15 is in the first state, the connector 10Y can be unlocked by applying a force on the first end 220a of the control portion 220 along a direction toward the second portion 120 of the operative portion 100Y (i.e. pressing the first end 220a of the control portion 220 toward the second portion 120 of the operative portion 100Y, as shown in FIG. 10B), wherein the second end 220b of the control portion 220 applies a force on the first end 200a of the positioning member 200Y along a direction away from the connection member 500, thus the positioning member 200Y moves away from the connection member 500 and thereby disengages with the first positioning portion 317 and the second positioning portion 417. Thence the first link 300 and the second link 400 are allowed to be rotated, as an angle between the first link 300 and the second link 400 is decreased from the first angle θ₁ to an angle less than the first angle θ₁. The mechanical structure 15 is thereby stowed. It is noteworthy that the angle between the first link 300 and the second link 400 are limited within a range from the first angle θ₁ to the predetermined second angle θ₂ less than the first angle θ₁ by the first protrusion 116, the second protrusion 116′ as well as the first stowing limiting portion 312 of the first link 300 and the second stowing limiting portion 412 of the second link 400, as previously discussed in FIG. 3 to FIG. 7.

When an angle between the first link 300 and the second link 400 is less than the first angle θ₁, by increasing the angle between the first link 300 and the second link 400 from an angle less than the first angle θ₁ (e.g. the second angle θ₂) to the first angle θ₁, as well as an angle between the first part 551 and the second part 552, the positioning member 200Y moves toward the connection member 500 thence engages with the first positioning portion 317 of the first link 300 and the second positioning portion 417 of the second link 400. The mechanical structure 15 is thereby transferred to the first state while the first link 300 and the second link 400 are locked.

In some embodiments, in order to ameliorate the connection between the control portion 220 and the positioning member 200Y, the second end 220b of the control portion 220 has a shape engaging with a through hole configured on the first end 200a of the positioning member 200Y. In some embodiments, the second end 220b of the control portion 220 has a T-shape, a hook shape, a curved shape, or a shape at least partially surround the positioning member 200Y.

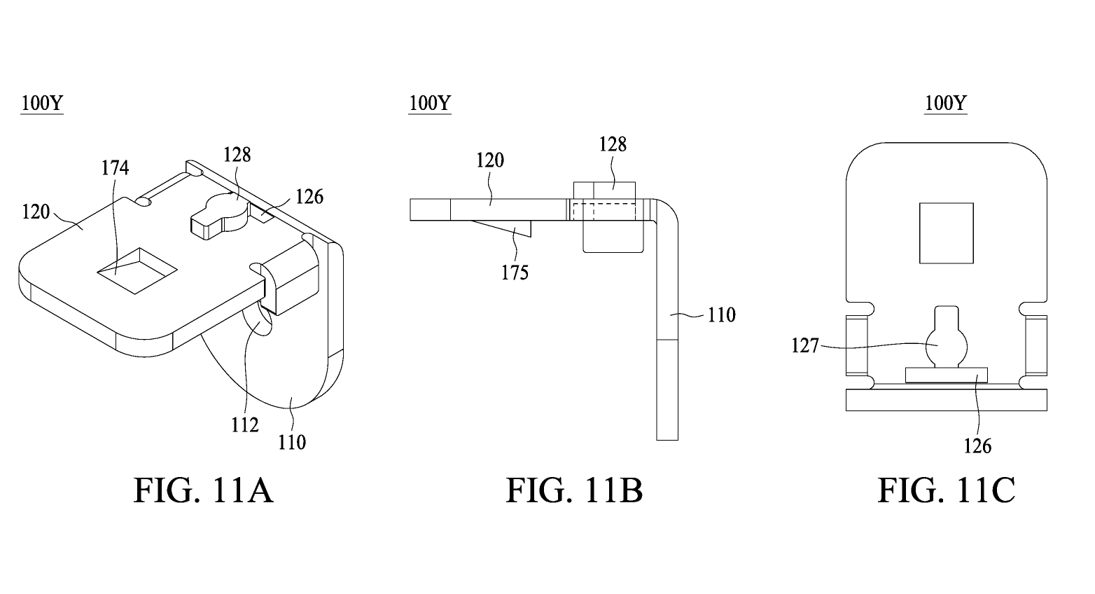

Referring to FIG. 9, FIG. 11A, FIG. 11B, and FIG. 11C, FIG. 11A is a perspective view showing an operative portion, FIG. 11B is a cross sectional view showing an operative portion, FIG. 11C is a bottom view showing an operative portion, in accordance with some embodiments of the present disclosure. In some embodiments, the operative portion 100Y may include a recess 127 recessed from the second side BS, and optionally include a protrusion 128 protruded from the first side FS. The recess 127 may accommodate a longer elastic member 123 so that the elastic member 123 can store greater potential energy. The protrusion 128 may contact with at least a surface of the positioning member 200Y so that the positioning member 200Y may be moved in a stabilized fashion without undue shaking.

In some embodiments, a sleeve 150 may at least cover a portion of the second portion 120 of the operative portion 100Y while a sleeve 250 may at least cover a portion of the first end 220a of the control portion 220 so that a user can apply force on a mild surface, wherein a sharp edge, burr, metal edge, or rough surface can be covered by the sleeve 150 and the sleeve 250, thus incise injury can be avoided. The sleeve 150 and the sleeve 250 may include plastic, polymer, rubber, organic substances, or the like. In some embodiments, the second portion 120 of the operative portion 100Y and the first end 220a of the control portion 220 may include a mating engagement structure, such as protrusions 175 and recesses 174, to ameliorate adhesion with the sleeve 150 and the sleeve 250 respectively.

In some embodiments, the positioning member 200Y or the control portion 220 include metal or metal alloy, so that the reliability thereof is improved. In some embodiments, the positioning member 200Y or the control portion 220 includes hard plastic or polymer to reduce cost while sustaining adequate durability.

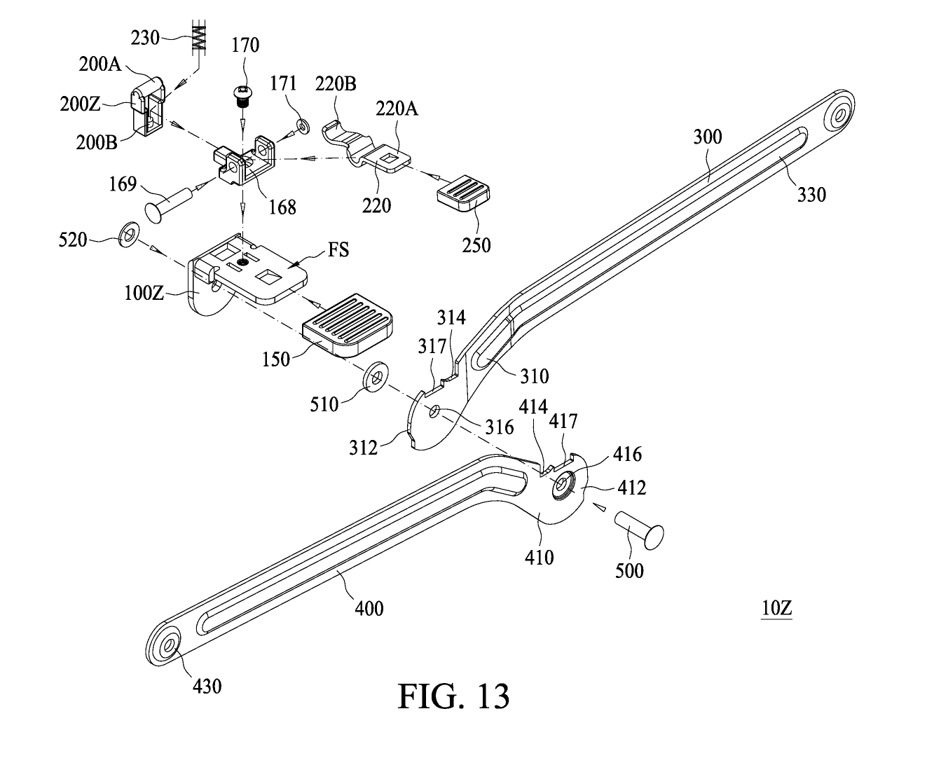

Referring to FIG. 12 and FIG. 13, FIG. 12 is a perspective view showing a connector 10Z in a first state, and FIG. 13 is an exploded view of a connector 10Z, in accordance with some embodiments of the present disclosure. Note that hereinafter elements in FIG. 12 to FIG. 19 being the same as or similar to aforesaid counterparts within FIG. 3 to FIG. 7 and FIG. 8 to FIG. 11C are denoted by the same reference numerals, as duplicated explanations are omitted. The connector 10Z includes a first link 300, a second link 400, an operative portion 100Z (which is a variation of the operative portion 100Y), a positioning member 200Z (which is a variation of the positioning member 200Y), a control portion 220, a connection member 500, a shaft 169, and a shaft base 168. The configuration of the connector 10Y and the connector 10Z are similar, however, by incorporating the shaft 169 and a shaft base 168 thereto, the reliability of the control portion 220 can be further improved. Similar to the counterpart in the connecter 10Y, the control portion 220 may include the curved portion 220c concaved toward the second portion 120 of the operative portion 100Z. In some embodiments, an angle between the first portion 110 and the second portion 120 is about 90 degrees. In some embodiments, no relative motion occurs between the first portion 110 and the second portion 120 herein.

In order to further ameliorate the stability, the shaft base 168 is disposed on the first side FS of the second portion 120 of the operative portion 100Z, the shaft 169 is disposed on the shaft base 168, and the control portion 220 is disposed between the shaft 169 and the shaft base 168, wherein the curved portion 220c surrounds at least a portion of the shaft 168, so that the control portion 220 may rotate around the shaft 169 with improved smoothness. The shaft 168 may also limit the control portion 220 to avoid unacceptable shaking or detachment. It is noteworthy that the curved portion 220c of the control portion 220 may contact with the shaft base 168, wherein a contacted area/line/point between the control portion 220 and the shaft base 168 of the operative portion 100Z can serve as a pivot.

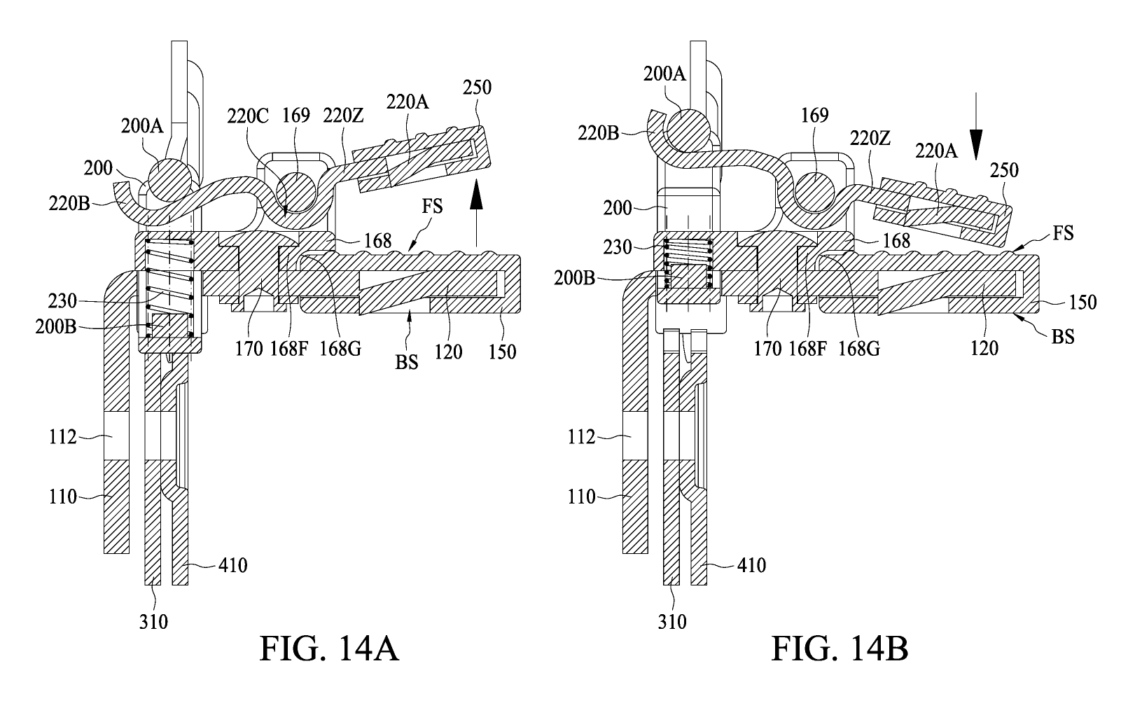

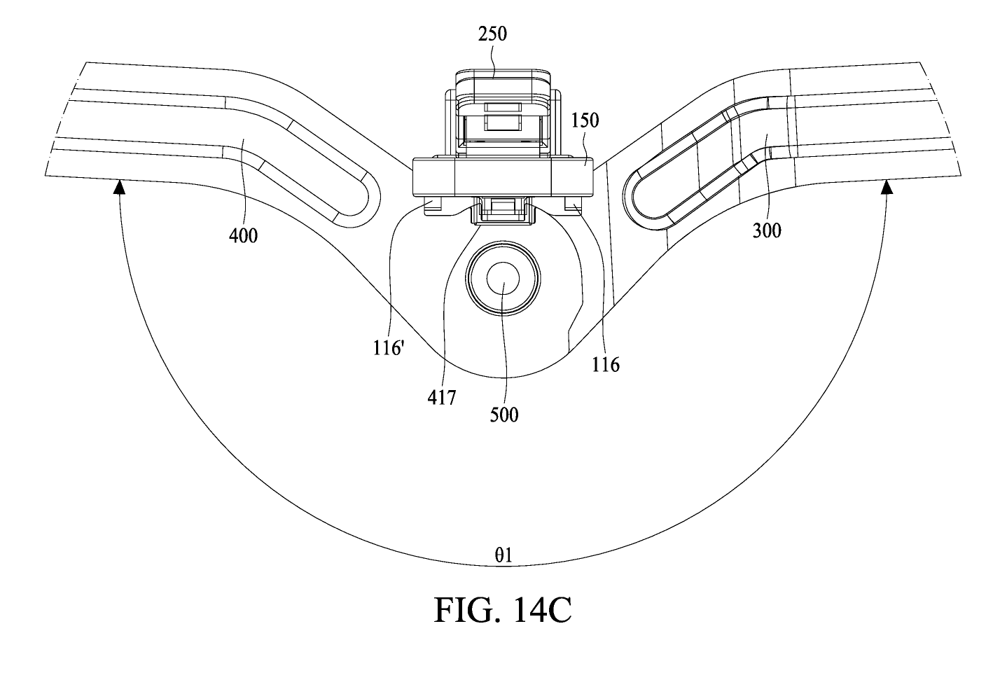

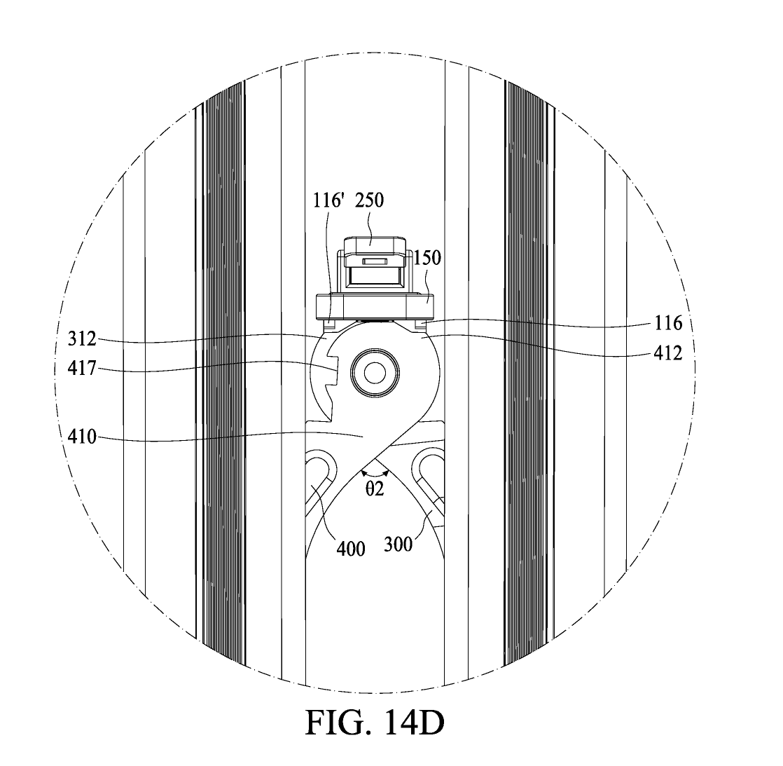

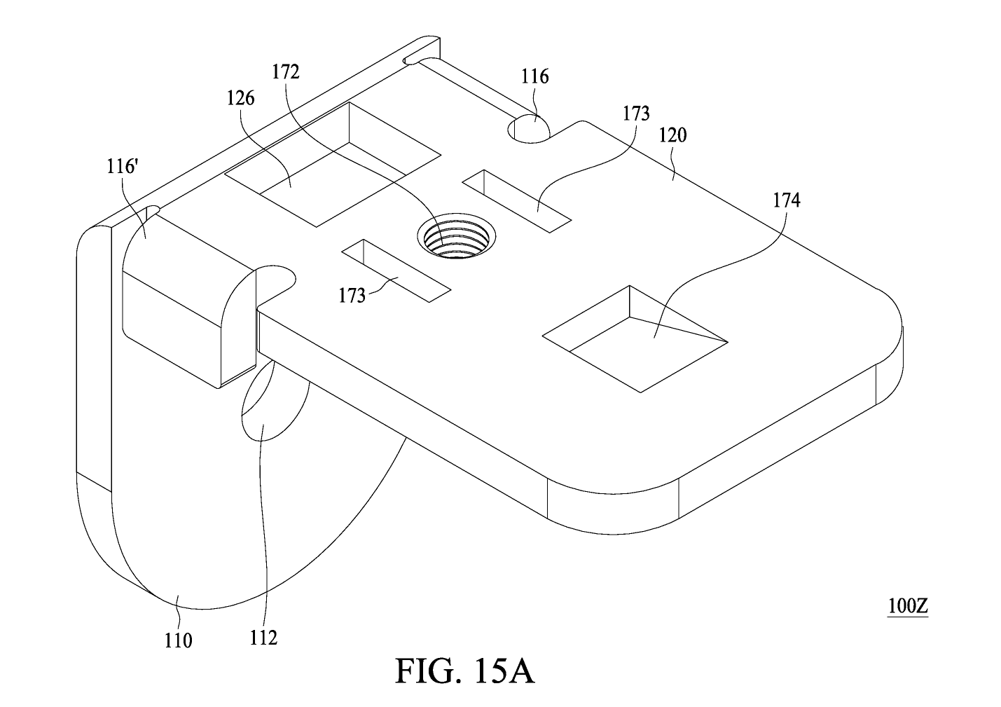

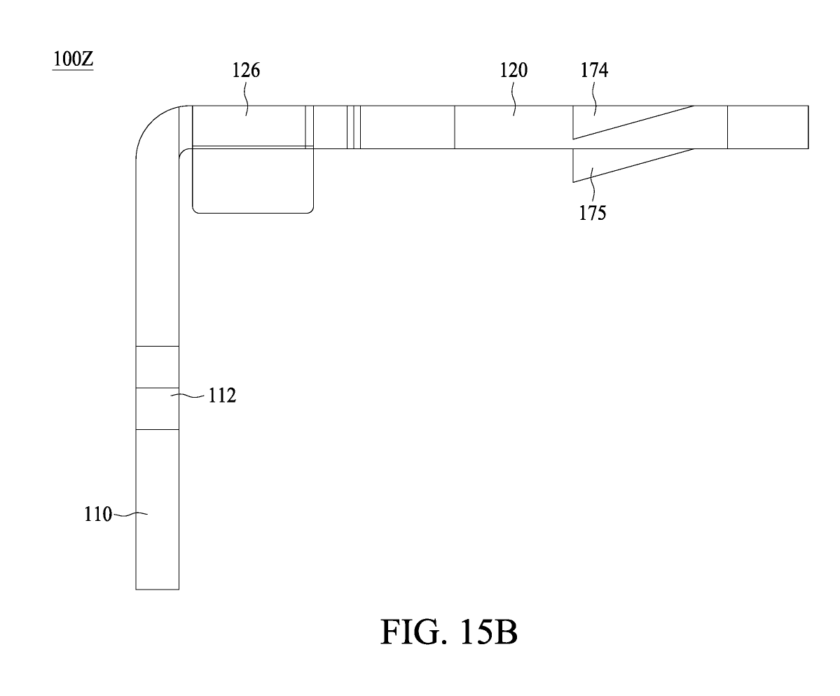

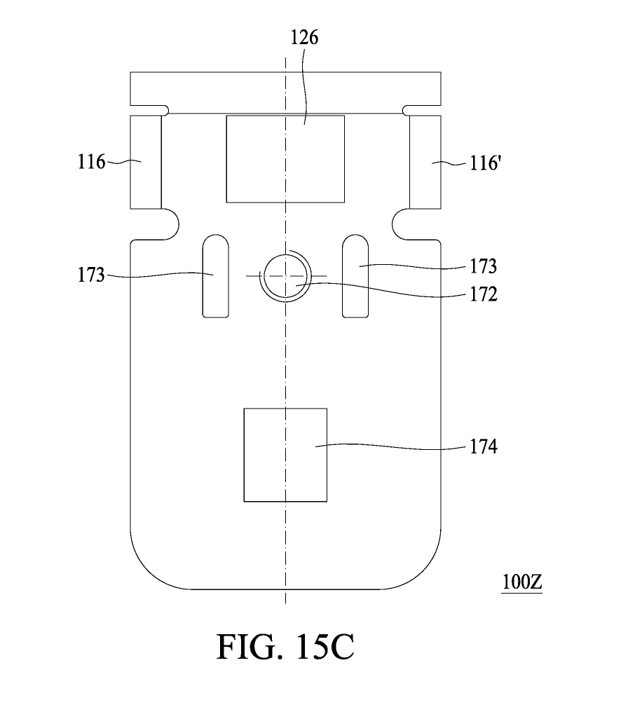

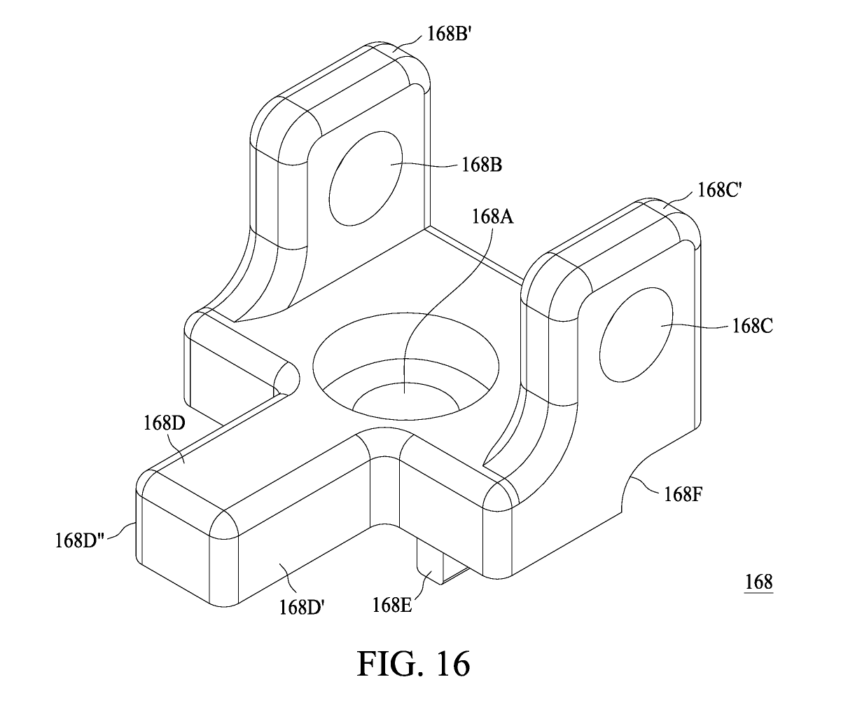

Referring to FIG. 13, FIG. 14A, FIG. 14B, FIG. 15A, FIG. 15B, FIG. 15C and FIG. 16, FIG. 14A is a cross sectional view of a control portion, an operative portion, and a positioning member in a first state, FIG. 14B is a cross sectional view of a control portion, an operative portion, and a positioning member in a second state, FIG. 15A is a perspective view showing an operative portion, FIG. 15B is a cross sectional view showing an operative portion, FIG. 15C is a bottom view showing an operative portion, and FIG. 16 is a perspective view showing a shaft base, in accordance with some embodiments of the present disclosure. A fixture 170 may fixate the shaft base 168 on the first side FS of the second portion 120 of the operative portion 100Z, as a mounting hole 172 is configured on the second portion 120 of the operative portion 100Z to mate with the fixture 170. In some embodiments, the fixture 170 may be a screw, as the mounting hole 172 may include screw thread. In some embodiments, the fixture 170 may be a rivet, as the rivet penetrates through the mounting hole 172 and engage with the second side BS of the second portion 120 of the operative portion 100Z. In some embodiments, in order to further ameliorate stability, one or more slot 173 is optionally configured through the second portion 120 of the operative portion 100Z as the shaft base 168 may include protrusions 168E for mating or sticking with the slot 173. In some embodiments, the shaft base 168 may include a mounting hole 168A to receive the fixture 170, wherein the mounting hole 168A may include a necking structure, that is, a top portion of the mounting hole 168A is wider than a bottom portion of the mounting hole 168A, as at least a portion of the fixture 170 can be accommodated into the top portion of the mounting hole 168A while a back surface of the fixture 170 is in contact with an interior top surface of the necking structure, thus fixation thereof can be boosted as the size of the connector 10Z may be reduced.

The shaft base 168 may include a first sidewall 168W and a second sidewall 168C′, as a first shaft hole 168B and a second shaft hole 168C can be configured on the first sidewall 168W and the second sidewall 168C′ respectively. The first shaft hole 168B and the second shaft hole 168C may stably accommodate the shaft 169. The first shaft hole 168B and the second shaft hole 168C may, or may not be through holes. In some embodiments, the shaft 169 is a rivet, as the rivet may be in contact with an outer surface of the first sidewall 168W and/or an outer surface of the second sidewall 168C′. In some other embodiments, a ring 171 is optionally included to increase contact area between the shaft 169 and the first sidewall 168W and/or the second sidewall 168C′. In some embodiments, the shaft base 168 or the shaft 169 may include metal or metal alloy, so that the reliability thereof is improved. In some embodiments, the shaft base 168 or the shaft 169 may include hard plastic or polymer to reduce cost while sustaining adequate durability. The shaft 169 may be rotatable or fixed.

In some embodiments, a sleeve 150 may at least cover a portion of the second portion 120 of the operative portion 100Z while a sleeve 250 may at least cover a portion of the first end 220a of the control portion 220 so that a user can apply force on a mild surface, wherein a sharp edge, burr, metal edge, or rough surface can be covered by the sleeve 150 and the sleeve 250, thus incise injury can be avoided. The sleeve 150 and the sleeve 250 may include plastic, polymer, rubber, organic substances, or the like. In some embodiments, the second portion 120 of the operative portion 100Z and the first end 220a of the control portion 220 may include a mating engagement structure, such as protrusions 175 and recesses 174, to ameliorate adhesion with the sleeve 150 and the sleeve 250 respectively. The shaft base 168 may optionally include a concaved portion 168F, so that a portion of the sleeve 150 may be interposed between the shaft base 168 and the second portion 120 of the operative portion 100Z. Thence the size of the operative portion 100Z can be reduced.

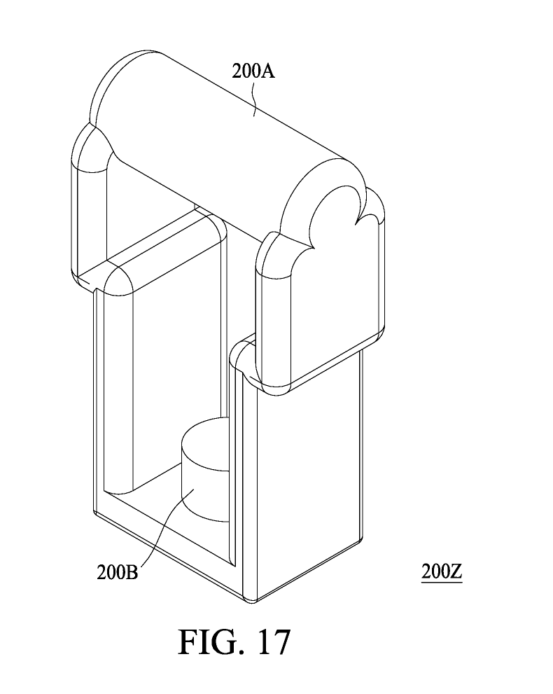

Referring to FIG. 13, FIG. 14A, FIG. 14B, FIG. 15A, FIG. 15B, FIG. 15C, FIG. 16 and FIG. 17, FIG. 17 is a perspective view showing a positioning member, in accordance with some embodiments of the present disclosure. An opening is configured on the second portion 120 of the operative portion 100Z, as the positioning member 200Z may penetrate through the opening 126. In some embodiments, the shaft base 168 optionally includes an extension portion 168D to penetrate through the positioning member 200Z. At least one of a first sidewall 168D′ of the extension portion 168D and a second sidewall 168D″ of the extension portion 168D may be in contact with the positioning member 200Z, so that the movement of the positioning member 200Z may be stabilized.

In some embodiments the first end 200a of the positioning member 200Z has a curved surface to engage with a curved surface of the second end 220b of the control portion 220 concaved toward the second portion 120 of the operative portion 100Z. The elastic member 230 is disposed between the second end 200b of the positioning member 200Z and a bottom of the shaft base 168 (e.g. a bottom surface of the extension portion 168D) or a bottom surface of the second portion 120 of the operative portion 100Z. In some embodiments, the second end 200b of the positioning member 200Z may include a post to stabilize the elastic member 230. In some embodiments, the positioning member 200Z may include metal or metal alloy, so that the reliability thereof is improved. In some embodiments, the positioning member 200Z may include hard plastic or polymer to reduce cost while sustaining adequate durability.

Referring back to FIG. 13, FIG. 14A, FIG. 14B, FIG. 14C, and FIG. 14D, FIG. 14C is an enlarged schematic view showing a front view of a connector 10Z in a first state, FIG. 14D is an enlarged schematic view showing a front view of a connector 10Z in a second state, in accordance with some embodiments of the present disclosure. In some embodiments, when the mechanical structure 15 (shown in FIG. 1) is in the first state, the first angle θ₁ is between the first link 300 and the second link 400. The first link 300 includes the first positioning portion 317 recessed toward the connection member 500, and the second link 400 includes a second positioning portion 417 recessed toward the connection member 500. In the first state, the first positioning portion 317 and the second positioning portion 417 are aligned, wherein the second end 200b of the positioning member 200Z engages with the first positioning portion 317 and the second positioning portion 417 and thus fixates the first link 300 and the second link 400. Alternatively stated, the second end 200b of the positioning member 200Z is configured to apply a force against the first positioning portion 317 and the second positioning portion 417 so that the first link 300 and the second link 400 is locked and may not be accidently rotated in an unpremeditated fashion.

When the mechanical structure is in the first state, the connector 10Z can be unlocked by applying a force on the first end 220a of the control portion 220 along a direction toward the second portion 120 of the operative portion 100Z (i.e. pressing the first end 220a of the control portion 220 toward the second portion 120 of the operative portion 100Z, as shown in FIG. 10B), wherein the second end 220b of the control portion 220 applies a force on the first end 200a of the positioning member 200Z along a direction away from the connection member 500, the control portion 220 rotates around the shaft 169, thus the positioning member 200Z moves away from the connection member 500 and thereby disengages with the first positioning portion 317 and the second positioning portion 417. Thence the first link 300 and the second link 400 are allowed to be rotated, as an angle between the first link 300 and the second link 400 is decreased from the first angle θ₁ to an angle less than the first angle θ₁ (e.g. the second angle θ₂). The mechanical structure 15 is thereby stowed. It is noteworthy that the angle between the first link 300 and the second link 400 are limited within a range from the first angle θ₁ to the predetermined second angle θ₂ less than the first angle θ₁ by the first protrusion 116 and the second protrusion 116′ and related configurations, as previously discussed in FIG. 3 to FIG. 7.

When an angle between the first link 300 and the second link 400 is less than the first angle θ₁ (e.g. the second angle θ₂), by increasing the angle between the first link 300 and the second link 400 from an angle less than the first angle θ₁ (e.g. the second angle θ₂) to the first angle θ₁, as well as an angle between the first part 551 and the second part 552, the control portion 220 rotates around the shaft 169 and the positioning member 200Z moves toward the connection member 500 thence engages with the first positioning portion 317 and the second positioning portion 417. The mechanical structure 15 is thereby transferred to the first state while the first link 300 and the second link 400 are locked.

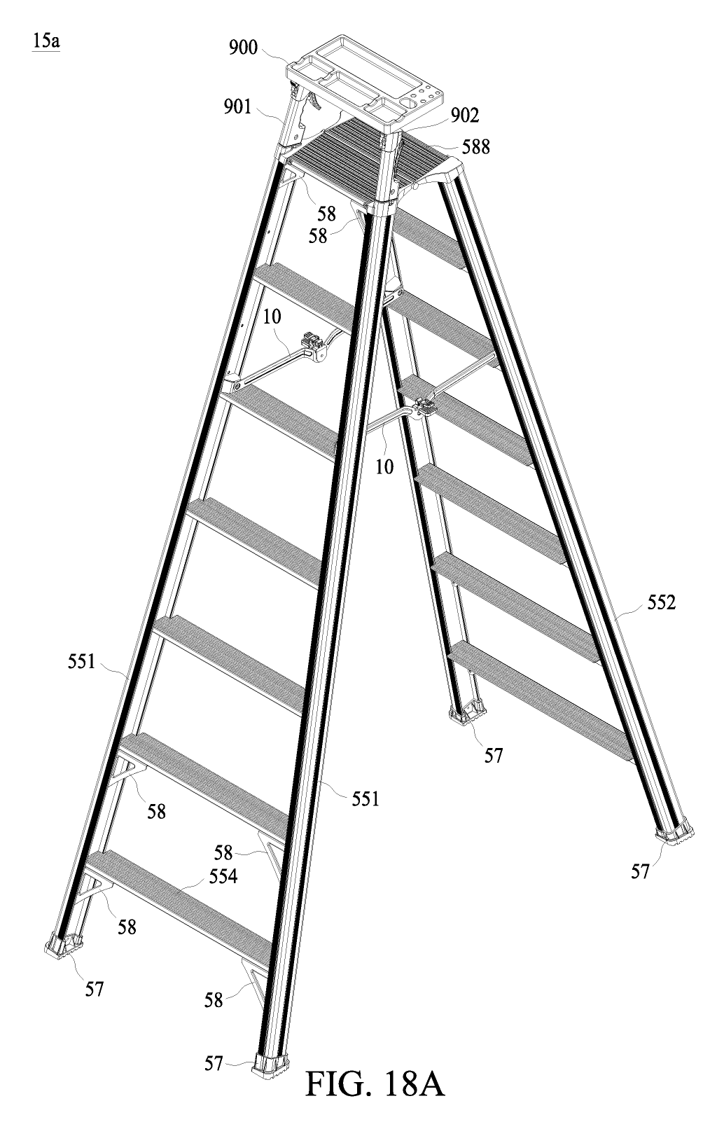

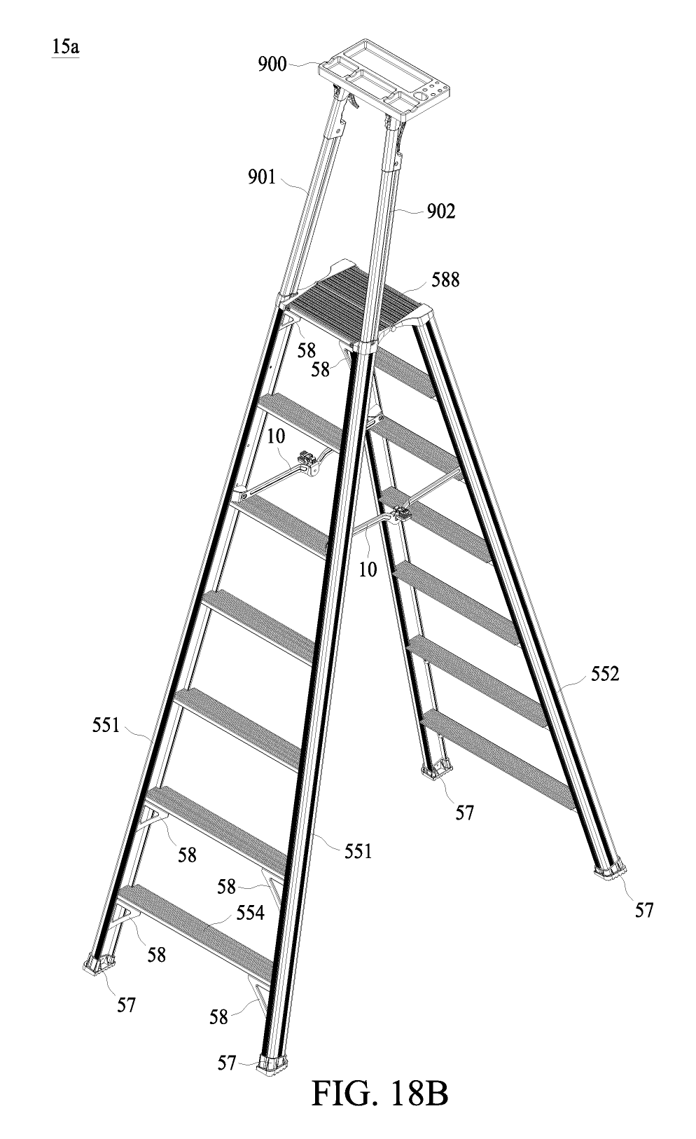

Referring to FIG. 18A and FIG. 18B, FIG. 18A is a perspective view showing a mechanical structure 15a in a first state, and FIG. 18B is a perspective view showing a mechanical structure 15a in a first state, in accordance with some embodiments of the present disclosure. In some embodiments, a trey 900 may be optionally disposed above the mechanical structure 15 provided in the present disclosure. In some embodiments, the trey 900 is connected to the first part 551 or the second part 552 by a first extendable structure 901 and a second extendable structure 902, wherein the first extendable structure 901 and the second extendable structure 902 illustrated in FIG. 18A can be extended to the position illustrated in FIG. 18B. In some other embodiments, the trey 900 is connected to the first part 551 or the second part 552 by a fixed structure. The trey 900 may provide extra storage, such as a platform for placing hand tools. In some embodiments, the trey 900 may include fast assembly structures for convenient attachment and detachment.

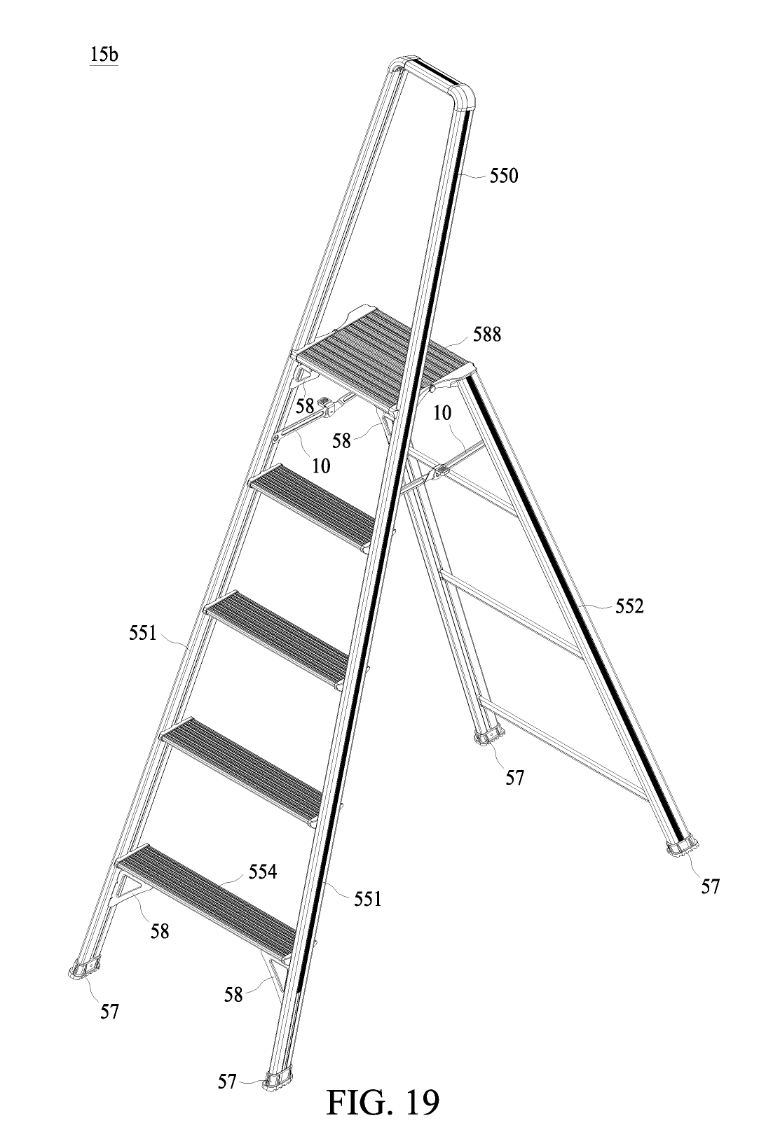

Referring to FIG. 19, FIG. 19 is a perspective view showing a mechanical structure 15b in a first state, in accordance with some embodiments of the present disclosure. In some embodiments, an extension structure 550 may be optionally disposed above the mechanical structure 15 provided in the present disclosure. The extension structure 550 may serve as a handle, or can be used for fixating a safety rope thereto.

Some embodiments of the present disclosure provide a mechanical structure, including a first link having a first end and a second end, a second link having a first end and a second end, an operative portion, wherein the operative portion comprises a first portion and a second portion unparalleled to the first portion, a connection member connecting the first end of the first link, the first end of the second link, and the first portion of the operative portion, a first protrusion on the second portion of the operative portion, a second protrusion on the second portion of the operative portion, wherein the first link is in contact with the first protrusion and the second link is in contact with the second protrusion when a first angle is between the first link and the second link.

Some embodiments of the present disclosure provide a mechanical structure, including a first link having a first end and a second end, wherein the first end comprises a first positioning portion, a second link having a first end and a second end, wherein the first end comprises a second positioning portion, an operative portion, wherein the operative portion comprises a first portion and a second portion unparalleled to the first portion, a connection member connecting the first end of the first link, the first end of the second link, and the first portion of the operative portion, a control portion above the operative portion, wherein the control portion comprises a first end and a second end, a positioning member connected to the second end of the control portion, wherein the positioning member engages with the first positioning portion and the second positioning portion when a first angle is between the first link and the second link.

The foregoing outlines features of several embodiments so that those skilled in the art may better understand the aspects of the present disclosure. Those skilled in the art should appreciate that they may readily use the present disclosure as a basis for designing or modifying other operations and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A mechanical structure, comprising:
a first link having a first end and a second end;
a second link having a first end and a second end;
an operative portion, wherein the operative portion comprises a first portion and a second portion unparalleled to the first portion;
a connection member connecting the first end of the first link, the first end of the second link, and the first portion of the operative portion;
a first protrusion on the second portion of the operative portion;
a second protrusion on the second portion of the operative portion, wherein the first link is in contact with the first protrusion and the second link is in contact with the second protrusion when a first angle is between the first link and the second link.

2. The mechanical structure of claim 1, further comprising a control portion on a first side of the second portion of the operative portion, wherein the control portion comprises a first end and a second end opposite to the first end.

3. The mechanical structure of claim 1, wherein the first protrusion and the second protrusion are on a second side facing the connection member.

4. The mechanical structure of claim 1, wherein the first protrusion and the second protrusion are configured to limit an angle between the first link and the second link to be in a range from the first angle to a second angle less than the first angle.

5. The mechanical structure of claim 4, wherein the first link is in contact with the second protrusion, the second link is in contact with the first protrusion when the second angle is between the first link and the second link.

6. The mechanical structure of claim 2, further comprising a positioning member connected to the second end of the control portion.

7. The mechanical structure of claim 6, wherein the first link comprises a first positioning portion recessed toward the connection member, and the second link comprises a second positioning portion recessed toward the connection member.

8. The mechanical structure of claim 7, wherein the positioning member is configured to apply a force on the first positioning portion and the second positioning portion along a direction away from the operative portion when the first angle is between the first link and the second link.

9. The mechanical structure of claim 6, further comprising an elastic member between the positioning member and the second portion of the operative portion.

10. The mechanical structure of claim 2, wherein if a force toward the second portion of the operative portion is applied on the first end of the control portion when the first angle is between the first link and the second link, the first link can be disengaged from the first protrusion.

11. The mechanical structure of claim 1, wherein if a force is applied on the second portion of the operative portion when the first angle is between the first link and the second link, the first link can be disengaged from the first protrusion.

12. A mechanical structure, comprising:
a first link having a first end and a second end, wherein the first end comprises a first positioning portion;
a second link having a first end and a second end, wherein the first end comprises a second positioning portion;
an operative portion, wherein the operative portion comprises a first portion and a second portion unparalleled to the first portion;
a connection member connecting the first end of the first link, the first end of the second link, and the first portion of the operative portion;
a control portion above the operative portion, wherein the control portion comprises a first end and a second end;
a positioning member connected to the second end of the control portion, wherein the positioning member engages with the first positioning portion and the second positioning portion when a first angle is between the first link and the second link.

13. The mechanical structure of claim 11, wherein the first positioning portion is recessed toward the connection member and the second positioning portion is recessed toward the connection member.

14. The mechanical structure of claim 11, wherein the positioning member applies a force on the first positioning portion and the second positioning portion along a direction away from the operative portion when the first angle is between the first link and the second link.

15. The mechanical structure of claim 11, wherein the positioning member penetrates the second portion of the operative portion.

16. The mechanical structure of claim 11, wherein the control portion comprises a curved portion concaved toward the operative portion.

17. The mechanical structure of claim 11, further comprising an elastic member configured to apply a force on the positioning member along a direction away from the operative portion.

18. The mechanical structure of claim 11, wherein the positioning member disengages from the first positioning portion and the second positioning portion when a second angle less than the first angle is between the first link and the second link.

19. The mechanical structure of claim 11, wherein the positioning member disengages from the first positioning portion and the second positioning portion when the first end of the control portion moves toward the operative portion.

20. The mechanical structure of claim 11, further comprising:
a shaft base disposed on the second portion of the operative portion; and
a shaft disposed on the shaft base, wherein the control portion is configured to rotate around the shaft.
